(19) United States
(12) Patent Application Publication
(10) Pub. No.: US 2014/0292354 A1
(43) Pub. Date: Oct. 2, 2014

(54) CAPACITIVE SENSOR

(71) Applicant: TEXAS INSTRUMENTS INCORPORATED, Dallas, TX (US)

(72) Inventors: Baher S. Haroun, Allen, TX (US); Rajarshi Mukhopadhyay, Allen, TX (US); Paul Merle Emerson, Murphy, TX (US)

(73) Assignee: Texas Instruments Incorporated, Dallas, TX (US)

(21) Appl. No.: 13/851,484

(22) Filed: Mar. 27, 2013

(51) Int. Cl. G01B 7/14; G11B 20/18

(52) U.S. Cl. CPC G01B 7/14; G11B 20/18
USPC 324/662

(57) ABSTRACT

A capacitive sensor has at least first and second conductive areas so that a first capacitance is formed between the first conductive area and a surface, and a second capacitance is formed between the second conductive area and the surface, and the ratio of the first capacitance to the second capacitance has a predetermined value only when the sensor is at a predetermined distance from the surface.

### BACKGROUND

There are many electronic systems in which precision measurement of a capacitance is needed. For example, capacitive sensing is used for touch screens, for testing electrical continuity on circuit boards, and for detecting proximity, position, or displacement. For some systems, the capacitance being measured is extremely small and the measurement accuracy requires extremely low-noise accurate circuitry. Measurement accuracy is complicated by mechanical vibration, electromagnetic fields, and other electronic noise. In addition, if transmission lines are needed between a sensor and circuitry used to measure capacitance, then transmission line length, transmission line impedance, propagation delay, and transmission line reflections can make determination of capacitance difficult. There is an ongoing need for improved measurement of capacitance.

### BRIEF DESCRIPTION OF THE DRAWINGS

FIG. 1A is a cross-section illustrating an example embodiment of a disk and a head with provision for capacitive measurement of fly height.

FIG. 1B is a cross-section illustrating an alternative example embodiment of a disk and a head with provision for capacitive measurement of fly height.

FIG. 1C is a cross-section illustrating an alternative example embodiment of a disk and a head with provision for capacitive measurement of fly height.

FIG. 2 is a block diagram illustrating an example embodiment of a circuit for use with the disk and head of FIG. 1.

FIG. 3 is a block diagram illustrating an alternative example embodiment of a head with provision for capacitive measurement of fly height and capacitive measurement of tilt.

FIG. 4 is a cross-section illustrating an example embodiment of a capacitive probe for measurement of properties of a thin film.

FIG. 5 is a flow chart illustrating an example embodiment of a method.

### DETAILED DESCRIPTION

One specific example of a need for precision measurement of a capacitance is dynamic measurement of the distance between a head and a disk in a disk drive. In a rotating disk drive (magnetic or optical), a transducer (head) is suspended very close to a spinning disk. Typically, the spacing between the head and the disk (called “fly height”) is just a few nanometers. The fly height needs to be low to maintain high signal to noise ratio for data signals. However, if the fly height is too low, there is a danger that the head might touch the disk, resulting in loss of data, damage to the head, and damage to the surface of the disk. Dynamic measurement of fly height is needed for closed-loop control of fly height.

Multiple techniques have been developed for measurement of fly height, including for example, monitoring the amplitude of signal harmonics, measurement of signal to noise ratio, light interferometry, and capacitive measurements. For example, in U.S. Pat. No. 4,931,887, a capacitance is formed by conductive patterns on a head and a disk, and the capacitance is driven by an RF voltage. In U.S. Pat. No. 7,394,611, a capacitance between a head and a disk is driven by a periodic signal with a constant voltage slew rate. In U.S. Pat. No. 7,719,786, a capacitance between a head and a disk is driven by a modulated RF voltage. In U.S. Pat. No. 7,450,333, a capacitance between a head and a disk is compared to a reference capacitance. In some of these prior art examples, an absolute value of a single capacitance is measured. For the resolution required for active control of fly height, the relative change in capacitance that needs to be detected may be on the order of 0.25%, which for some embodiments may be as small as 5 fF. This requires extremely low-noise accurate circuitry. Capacitance measurement is complicated by mechanical vibration of the head and drive, electromagnetic fields around the head and other electronic noise. The surface of the disk may have a high impedance relative to ground, resulting in substantial electrical noise at the surface of the disk. In addition, if transmission lines are needed between the head and the circuitry used to measure capacitance, then transmission line length, transmission line impedance, propagation delay, and transmission line reflections can make determination of absolute capacitance difficult.

In the system described below, fly height is determined by measuring a ratio of two capacitances instead of just measuring a single absolute capacitance. A differential measurement of two voltages cancels common-mode noise and many of the transmission line effects, which greatly improves the signal-to-noise ratio for the capacitance measurement. In a specific example of a system for measuring head fly height, the system measures two voltages that are equal only when the fly height is at the desired distance. The two voltages are equal only when the ratio of two capacitances is at a predetermined value, which occurs only when the fly height is at the desired distance. At all other distances the ratio of the capacitances is not at the predetermined value. The ratio of the two capacitances may be 1.0 at the desired distance, or may be a predetermined value that is different than 1.0.

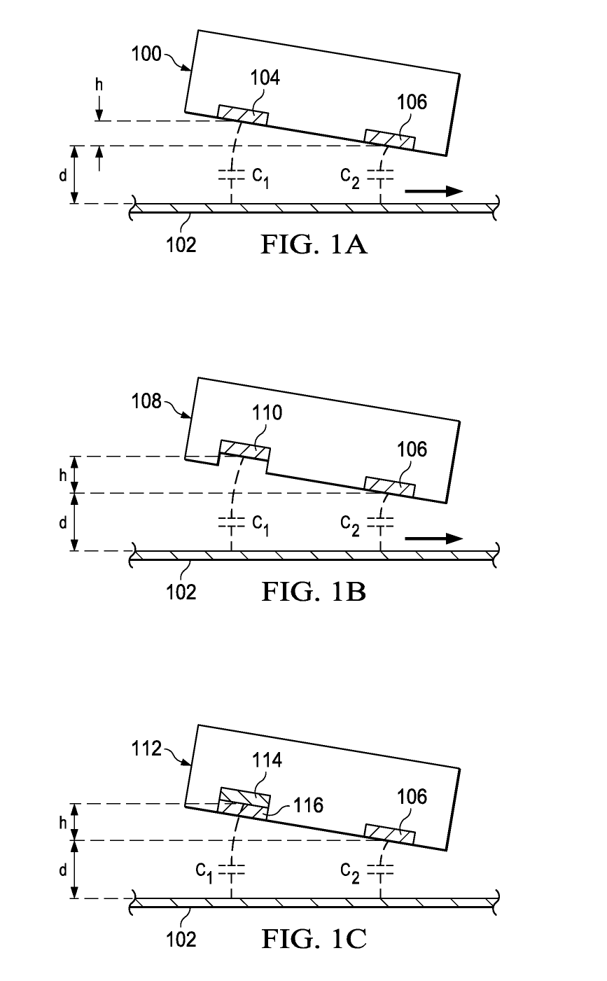

FIG. 1A illustrates an example embodiment of a head 100 with provisions for capacitive measurement of fly height. In FIG. 1, the head 100 may be, for example, a magnetic transducer or an optical transducer. The head 100 is positioned close to a spinning disk 102, where the arrow indicates the direction of spin. As illustrated in FIG. 1A, the head 100 may be intentionally tilted or skewed along the direction of spin to help the head “fly” on a cushion of air. If the head is not tilted along the direction of spin, then an alternative design illustrated in FIG. 1B may he used. The transducer may also be unintentionally tilted or skewed in a direction transverse to the direction of spin (which will be discussed further below).

The head 100 includes at least two conductive areas 104 and 106. A first capacitance C₁ is formed by the conductive area 104 and the surface of the disk 102, and a second capacitance C₂ is formed by the conductive area 106 and the surface of the disk 102. The center of the conductive area 106 is a distance “d” from the surface of the disk 102. The center of the conductive area 104 is a distance “d+h” from the surface of the disk 102. Assume that the conductive area 104 has an area of A₁, and assume that the conductive area 106 has an area of A₂. Capacitances C₁ and C₂ are then as follows:

C₁=εₒA₁/(d+h) C₂=εₒA₂/(d)

where εₒ is the permittivity of free space.

Define d_{D} as the desired distance from the center of the conductive area 106 to the surface of the disk 102, and let h=nd_{D}, where “n” is determined by the tilt angle. When d=d_{D}, then:

C₁/C₂=A₁/[(n+1)A₂]

That is, when the head 100 is at the desired distance from the disk 102, then the ratio of C₁ to C₂ is a known (predetermined) quantity.

Areas A₁ and A₂ may optionally be designed so that A₁=(n+1)A₂, so that C₁=C₂ when the head 100 is at the desired distance from the disk 102. Alternatively, when the head is at the desired distance from the disk 102, the ratio C₁/C₂ may be different than 1:1 as long as the ratio is known a priori. In particular, if A₁=kA₂, then:

C₁/C₂=k/(n+1)

Alternatively, C₁ and C₂ may be varied by recessing (or bumping out) one of the conductive areas to change “h” and/or “d”. This may be needed if the head does not have an intentional tilt or if the tilt is relatively insignificant. For example, in FIG. 1B, a head 108 has one conductive area 110 recessed into the head 108. The distance “h” may still be defined as nd_{D}, but recessing the conductive area 110 allows the parameter “n” to be made independent of the tilt angle of the head 108.

Alternatively, C₁ and C₂ may be varied by changing the permittivity between at least one conductive area and the surface of the disk 102. For example, in FIG. 1C, a head 112 includes a conductive area 114, and a dielectric layer 118 between the conductive area 114 and the surface of the disk 102. The dielectric layer 116 has a permittivity that is different than the permittivity of free space.

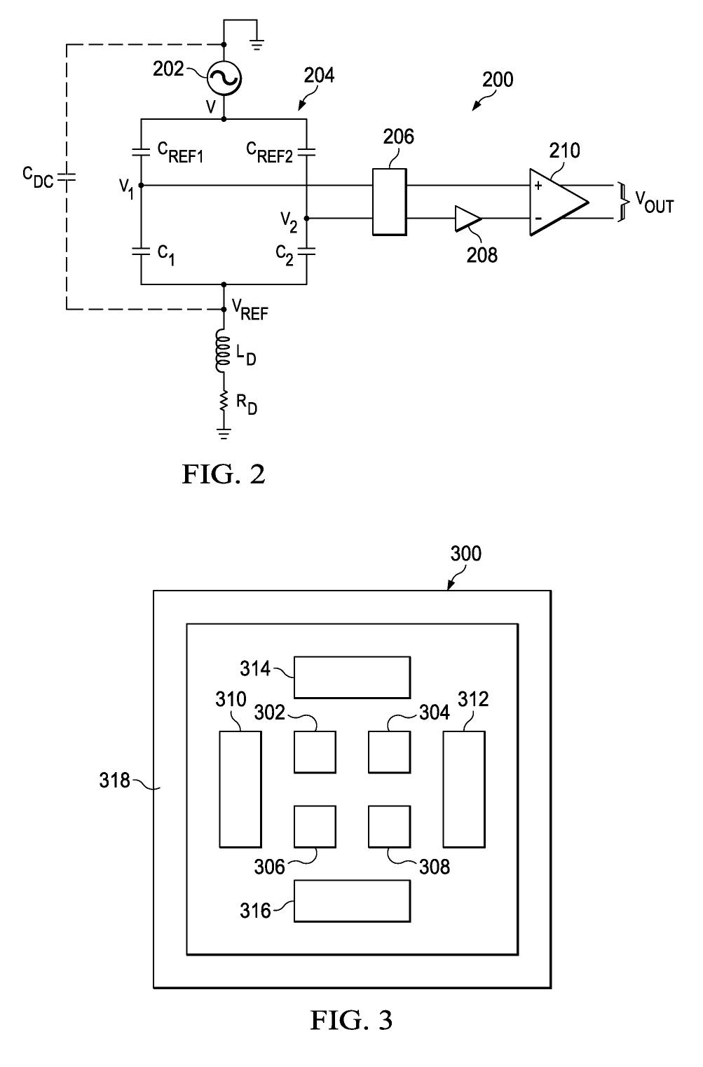

FIG. 2 illustrates an example embodiment of a circuit 200 for use with any of the heads (100, 108, 112) of FIGS. 1A-1C. In the example of FIG. 2, a radio frequency (RF) voltage source 202 drives a capacitive bridge 204 at a voltage “V”. Voltage “V” is relative to V_{REF}, where V_{REF} may be, for example, the voltage at the surface of the disk 102 (which may be floating or at a high impedance). The capacitive bridge 202 includes two reference capacitances (C_{REF1}, C_{REF2}), and two head-disk capacitances (C₁, C₂) as in FIGS. 1A-1C. C_{REF1} and C_{REF2} may be trimmed at the time of manufacture. Within the capacitive bridge 204, voltage V₁ is V*C₁/(C₁+C_{REF1}), and voltage V₂ is V*C₂/(C₂+C_{REF2}). Optional circuitry 206 may include signal buffers and/or band-pass filters. Optional amplifier 208 may, for example, have a gain of (n+1)/k if C₁/C₂=k/(n+1) at the desired fly height. An analog comparator (or differential amplifier) 210 compares V₁ and V₂ (as optionally modified by circuit elements 206 and 208). Assuming C_{REF1}=C_{REF2}, then the differential output V_{OUT} of comparator 210 is zero when distance “d” is equal to the desired distance “d_{D}”. V_{OUT} may be, for example, positive if the fly height is too high and negative if the fly height is too low.

In FIG. 2, inductance L_{D} and resistance R_{D} represent the impedance of the surface of the disk 102 to ground. If the impedance of the surface of the disk 102 to ground is high, then a large capacitance (>10*C₁) C_{DC} in parallel with the bridge circuit 204 may be needed to provide an AC ground at the surface of the disk 102.

The examples of FIGS. 1A-1C illustrate a head with two conductive areas. Optionally, a head may include an array of conductive areas for measurement of fly height and/or head tilt in a direction transverse to the surface of the disk 102. FIG. 3 illustrates the surface of a head 300 having an array of conductive areas (302-316). For example, conductive areas 302 and 304, and/or conductive areas 308 and 308, may be used in pairs to measure fly height. Alternatively, conductive areas 302 and 308, and/or conductive areas 304 and 306 may be used in pairs to measure fly height. Alternatively, conductive areas 302 and 308, and/or conductive areas 304 and 308 may he used in pairs to measure tilt transverse to the direction of rotation of the disk 102. Alternatively, conductive areas 310 and 312 may be used to measure fly height, and conductive areas 314 and 316 may be used to measure tilt transverse to the direction of rotation of the disk 102. The entire array may he surrounded by a large conductive area 318, which forms capacitance C_{DC} for providing a virtual ground, as illustrated in FIG. 2.

Consider, for example, conductive areas 314 and 316. Assume that conductive areas 314 and 316 are at the surface of the head as in FIG. 1A. Assume further that conductive area 314 and the surface of the disk 102 form a capacitance C₁, and that conductive area 316 and the surface of the disk 102 form a capacitance C₂, and that a bridge circuit as in FIG. 2 is used. For purposes of transverse tilt measurement, the output of comparator 210 is zero when both conductive areas 314 and 316 are the same (desired) distance from the disk (that is, the output of comparator 210 is zero when there is no tilt transverse to the direction of rotation of the disk 102).

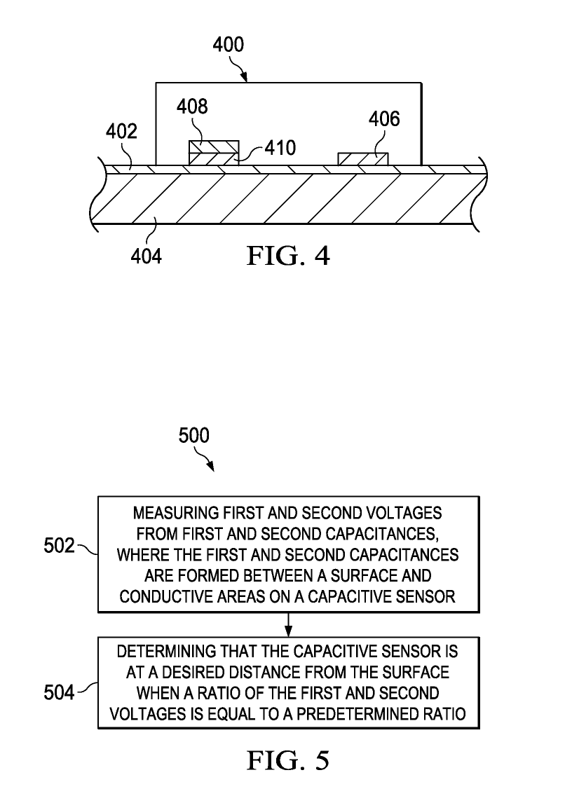

The above examples use measurement of a capacitance ratio to verify a proper distance of a head near a spinning disk. An alternative example of measuring a capacitance ratio is a probe for measuring the thickness (and permittivity or dielectric constant) of thin dielectric films. FIG. 4 illustrates an example capacitive probe 400 being used to verify the thickness (and permittivity or dielectric constant) of a dielectric layer 402 on a stationary substrate 404. In the example of FIG. 4, the surface of the probe 400 is in contact with the dielectric layer 402 but that is not necessary. The probe 400 includes two conductive areas 406 and 408. In the illustrated example, one conductive area 408 is recessed into the surface of the probe 400. Also in the illustrated example, an example additional dielectric layer 410 is fabricated between conductive area 408 and the surface of the probe 400. The additional dielectric layer 410 is also optional.

A first probe capacitance is formed between the conductive area 406 and a surface of the substrate 404, as determined by the area of the conductive area 406, the thickness of the dielectric layer 402, and the permittivity of the dielectric layer 402. A second probe capacitance is formed between the conductive layer 408 and the surface of the substrate 404, as determined by the area of the conductive area 408, the thickness of the dielectric layer 402, the distance between the conductive area 408 and the dielectric layer 402, and the effective permittivity of any materials (including, for example, air) between the conductive area 408 and the substrate 404.

The circuit of FIG. 2 may be used for the probe 400 of FIG. 4. Again, a differential measurement of two voltages cancels common-mode noise and many of the transmission line effects, which greatly improves the signal-to-noise ratio for the capacitance measurement. In a specific example of a system for measuring thin film properties, the system measures two voltages that are equal only when the thin film has the expected thickness (and permittivity). The two voltages are equal only when the ratio of the two probe capacitances is at a predetermined value, which occurs only when the thin film (dielectric layer 402) has the expected thickness (and permittivity). For ail other thicknesses (and permittivities) of the thin film (dielectric layer 402), the ratio of the probe capacitances is not at the predetermined value. The ratio of the two probe capacitances may be 1.0 when the thin film (dielectric layer) has the expected thickness (and permittivity), or may be a predetermined value that is different than 1.0. The areas of the conductive areas 406 and 408, the distance between conductive area 408 and the dielectric layer 402, and permittivity of optional layer 410 may all be adjusted so that the output of comparator 210 will be zero only if the dielectric layer 402 has the expected thickness (and permittivity). For example, such a probe may be used in a production environment to verify that a thin film, for example, a thin film on solar cells, has been properly formed.

FIG. 5 illustrates an example method 500 for verifying a distance using a capacitive sensor, for example, measuring fly height or thin film thickness. At step 502. first and second voltages are measured from first and second capacitances, where the first and second capacitances are formed between a surface and conductive areas on the capacitive sensor. At step 504, the capacitive sensor is determined to be at a desired distance from the surface when a ratio of the first and second voltages is equal to a predetermined ratio.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A capacitive sensor, comprising;
at least first and second conductive areas, so that a first capacitance is formed between the first conductive area and a surface, and a second capacitance is formed between the second conductive area and the surface; and
the ratio of the first capacitance to the second capacitance having a predetermined value only when the capacitive sensor is at a predetermined distance from the surface.

2. The capacitive sensor of claim 1, where the predetermined value, of the ratio of the first capacitance to the second capacitance when the capacitive sensor is at a predetermined distance from the surface, is equal to one.

3. The capacitive sensor of claim 1, where the predetermined value, of the ratio of the first capacitance to the second capacitance when the capacitive sensor is at a predetermined distance from the sensor, is not equal to one.

4. The capacitive sensor of claim 1, further comprising at least one of the first and second conductive areas recessed below a surface of the capacitive sensor.

5. The capacitive sensor of claim 1, further comprising a dielectric layer between at least one of the first and second conductive areas and the surface.

6. The capacitive sensor of claim 1, further comprising an array of at least four conductive areas on the capacitive sensor.

7. The capacitive sensor of claim 1, where the capacitive sensor is on a head for a disk drive.

8. The capacitive sensor of claim 7, where the surface is the surface of a disk.

9. The capacitive sensor of claim 1, where the predetermined distance is a predetermined thickness of a thin film on a substrate.

10. The capacitive sensor of claim 9, where the surface is a surface on the substrate.

11. A circuit, comprising:
a capacitive bridge, comprising a first reference capacitance in series with a first sensor capacitance, and a second reference capacitance in series with a second sensor capacitance, where the first and second sensor capacitances are formed between conductive areas on a capacitive sensor and a surface;
a comparator comparing a first voltage, from the junction of the first reference capacitance and the first sensor capacitance, to a second voltage, from the junction of the second reference capacitance and the second sensor capacitance.

12. The circuit of claim 11, where the output of the comparator is zero only when a ratio of the first and second voltages is equal to a predetermined value.

13. The circuit of claim 11, where the conductive areas are on a head for a disk drive and the surface is a surface of a disk.

14. A method, comprising:
measuring first and second voltages from first and second capacitances, where the first and second capacitances are formed between a surface and conductive areas on a capacitive sensor; and
determining that the capacitive sensor is at a desired distance from the surface when a ratio of the first and second voltages is equal to a predetermined ratio.
